(19) United States
(12) Patent Application Publication
(10) Pub. No.: US 2003/0133652 A1
(43) Pub. Date: Jul. 17, 2003

(54) Method and apparatus for improving performance in noise limited optical transmission systems

(76) Inventors: Peter A. Andrekson, Macungie, PA (US); Jonas Hansryd, Allentown, PA (US)

Correspondence Address: VOLENTINE FRANCOS, P.L.L.C., Suite 150, 12200 Sunrise Valley Drive, Reston, VA, 20191, US

(21) Appl. No.: 10/303,471

(22) Filed: Nov. 25, 2002

Related U.S. Application Data
(60) Provisional application No. 60/348,813, filed on Jan. 15, 2002.

(51) Int. Cl. G02B 6/26

(52) U.S. Cl. 385/27

(57) ABSTRACT

A method and apparatus for improving the performance in OSNR-limited systems includes selective pre-chirping of a transmitted optical signal, such that, in combination with the link dispersion, a net pulse compression is obtained at the receive end of an optical link.

### CROSS-REFERENCE TO RELATED APPLICATIONS

The present application claims priority under 35 USC § 119(e) from U.S. Provisional Application No. 60/348,813, entitled “Method For Utilizing Chirp in Laser Transmitters to Provide Improved Performance In Optical Noise Limited Fiber Transmission Systems” filed on Jan. 15, 2002. The disclosure of the above referenced provisional application is incorporated herein by reference and for all purposes.

### FIELD OF THE INVENTION

The present invention relates generally to optical communications, and particularly to method and apparatus for improving performance in noise limited optical transmission systems.

### BACKGROUND

Optical noise from various sources can be a significant impediment to the signal transmission quality in optical communications systems. The noise may be from a variety of sources. One source of noise is amplifier devices used in long haul optical links. These amplifiers are useful and often essential to reverse attenuation of the optical signal as it traverses the transmission medium, which is often an optical fiber. As is known, the accumulation of the noise from the amplification stages ultimately can degrade the optical signal-to-noise ratio (OSNR), and therefore, the bit error rate (BER) to an unacceptable level.

Another phenomenon that can have deleterious effects on optical signal quality, and therefore the BER, is chromatic dispersion. As is well known, chromatic dispersion often arises is optical fibers due to the wavelength dependence of the index of refraction. Consequently, higher frequency components of optical signals will “slow down,” and contrastingly, lower frequency signals will “speed-up,” or vice versa, depending on the sign of the chromatic dispersion.

In digital optical communications, where the optical signal is comprised ideally of square-waves, bit-spreading due to chromatic dispersion can be particularly problematic, and the shape of the waveform can be substantially impacted. The effects of this type of dispersion are a spreading of the original pulse in time, causing it to overflow in the time slot that has already been allotted to another bit. When the overflow becomes excessive, intersymbol interference (ISI) may result. ISI may result in an increase in the BER to unacceptable levels.

While there are known techniques used to mitigate the ill-effects of chromatic dispersion in optical signals, there are drawbacks and shortcomings associated with these known techniques. For example, in long-haul optical links, there are various shortcomings and drawbacks to known dispersion compensation methods and apparati.

What is needed, therefore, is a method and apparatus for compensating for chromatic dispersion in optical links that overcomes certain shortcomings and drawbacks of known methods and apparati.

### SUMMARY

In accordance with an exemplary embodiment of the present invention, a method of improving the performance in OSNR-limited systems includes selective pre-chirping of a transmitted optical signal, wherein the pre-chirping, in combination with the link dispersion, effects a net pulse compression at the receive end of an optical link.

In accordance with another exemplary embodiment of the present invention, an OSNR-limited optical communications link includes at least one chirped optical source, which selectively pre-chirps an optical signal, wherein the pre-chirped optical signal, in combination with the net non-zero chromatic dispersion of the link, effects a net pulse compression at a receive end of the optical link.

### BRIEF DESCRIPTION OF THE DRAWINGS

The invention is best understood from the following detailed description when read with the accompanying drawing figures. It is emphasized that the various features are not necessarily drawn to scale. In fact, the dimensions may be arbitrarily increased or decreased for clarity of discussion.

FIG. 1 is a representational view of an optical communications link in accordance with an exemplary embodiment of the present invention.

FIG. 2 is a graphical representation showing distribution of the optical power and wavelength versus time of a square-pulse at the input and the output of an optical link in accordance with an exemplary embodiment of the present invention.

FIG. 3 is a graphical representation of the power penalty versus net link dispersion showing the penalty improvement that results from an exemplary embodiment of the present invention.

FIG. 4 is a graphical representation of the transmission path penalty versus link dispersion (expressed in km of standard fiber) for different chirp values showing the improvement in the transmission path penalty as a result of the method and apparatus according to an exemplary embodiment of the present invention.

### DETAILED DESCRIPTION

In the following detailed description, for purposes of explanation and not limitation, exemplary embodiments disclosing specific details are set forth in order to provide a thorough understanding of the present invention. However, it will be apparent to one having ordinary skill in the art having had the benefit of the present disclosure, that the present invention may be practiced in other embodiments that depart from the specific details disclosed herein. Moreover, descriptions of well-known devices, methods and materials may be omitted so as to not obscure the description of the present invention.

Briefly, the present invention relates to a method and apparatus for providing an electrical SNR, Q-value, and bit-error rate (BER) that is acceptable at a receive-side of a long haul, OSNR limited optical communications link by pre-chirping the transmitted optical signal. Characteristically, the pre-chirping of the transmitted optical signal has a pre-chirp that is chosen for a residual dispersion of the optical link so that an optical signal at the receive-side of the link is compressed temporally. This could be an “up-chirp” having an increasing frequency (decreasing wavelength) with time or a “down-chirp”, having a decreasing frequency with time.

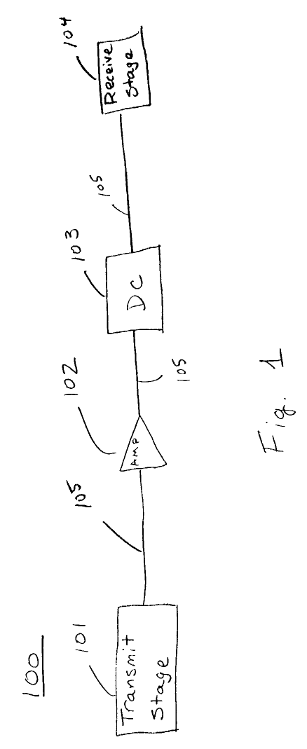

FIG. 1 shows optical communications link 100 in accordance with any exemplary embodiment of the present invention. The optical link 100 is a long-haul link, which incorporates at least one device that can degrade the OSNR of the optical link. Illustratively, the optical link has a length ranging from approximately 200 km to approximately 10,000 km, although the exemplary embodiments have applicability and benefits in OSNR-limited links of greater and lesser lengths.

The optical link 100 includes a transmit stage 101 that may include therein an optical source that introduces a pre-chirped optical signal into an optical waveguide 105, which is illustratively an optical fiber. The optical signal may be a wavelength division multiplexed (WDM), a dense WDM optical signal, or a time-division multiplexed (TDM) optical signal, although other multiplexing schemes may be employed in carrying out the exemplary embodiments.

The optical source (not shown) is illustratively an electro-absorptive modulated laser (EML), in which a chirp can be controlled by changing the bias voltage of the device. It is noted that this may not provide a linear chirp, but may be suitable for many links. A laser that is externally modulated with a Mach-Zehnder modulator may be used as the optical source. Such a device will provide excellent control of the chirp, as well as provide a linear chirp profile. Other techniques that may be used as the source of the chirp in keeping with the present exemplary embodiment include phase modulation via an external phase modulator or self-phase modulation in an optical fiber. In some embodiments, (e.g., when using an EML), the chirp may be generated at the transmit stage 101, while in other embodiments, the chirp may be generated at the receive stage 104. As will be appreciated as the present description continues, depending on the sign of the residual dispersion in the link, the sign (positive or negative) of the pre-chirp is chosen so that at the receive end of the link, the optical signal is compressed. Moreover, the magnitude of the pre-chirp is chosen to optimize the compression of the signal.

The optical link 100 may also include an amplification stage 102; or a plurality thereof distributed at intervals along the length of the link. Examples of such amplifiers include erbium doped fiber amplifiers (EDFA) and Raman amplifiers as well as other types of amplification stages commonly used in long-haul applications. These amplifiers often introduce deleterious noise into the optical signal that traverses the optical waveguide 105.

In a long-haul optical link, it is often necessary to have devices for mitigating the ill-effects of chromatic dispersion, which can result in an unacceptable BER. As such, dispersion compensators 103 may be distributed along the length of the optical link 100. Often, there remains a certain amount of residual dispersion in the optical link. Ultimately, the optical signals are transmitted across the optical link 100 and are received at a receive stage 104, which may convert the optical signal into an electrical signal that may be further processed/demodulated. As explained more completely herein, the sign and magnitude of the pre-chirp of the transmitted optical signal is chosen for net (or residual) dispersion of the link so that the received optical signal is temporally compressed, an improved electrical SNR, Q-factor and BER result, compared to a long-haul links that have a zero-chirp optical signal.

As referenced previously, the OSNR is degraded each time an optical amplification stage 102 is used to provide a signal boost along the optical link 100. This degradation is a substantially inevitable result of amplified spontaneous emission (ASE) in the link 100. In accordance with an exemplary embodiment pre-chirping of the optical signal is effected to achieve pulse compression to improve the electrical SNR, Q-value and BER at the receive stage of the optical link.

OSNR degradation or limitation can be particularly problematic in long-haul optical links. The OSNR is not dependent on the format of the data of the optical signal, the shape of the optical pulse, or the bandwidth of any filters in the link. The OSNR is only a function of the average optical signal power, P_{S}, and the average optical noise power density, P_{N}, normally expressed in Watts within a spectral range of approximately 0.1 nm:

$$OSNR = \frac{{P}_{S}}{{P}_{N}} \qquad ( 1 )$$

Moreover, the BER is directly related to the Q-factor, an electrical parameter. The Q-value is defined in a digital signal as:

Q=(I₁−I₀)/(σ₁+σ₀) (2)

where I₁ and I₀ are the average of the maximum detected signal currents for digital “ones” and “zeros,” and σ₁ and σ₀ are the corresponding detected rms noise values (assuming a non-return to zero format and an equal number of “ones” and “zeros”). The BER is related to the Q-factor as:

$$BER \approx \frac{1}{Q \sqrt{2 π}} exp ( - {Q}^{2} / 2 ) \qquad ( 3 )$$

It can be shown that the Q-factor relates to the OSNR when the optical noise is a dominant noise source and in the case of non-return-to-zero (NRZ) (i.e. square-shaped pulses) format as:

$$Q = \sqrt{125 \cdot {B}_{0} / {B}_{N}} \frac{2 OSNR \cdot 0.1 / {B}_{0}}{\sqrt{4 OSNR \cdot 0.1 / {B}_{0} + 1 + 1}} \qquad ( 4 )$$

where B₀ is the bandwidth of an optical bandpass filter in front of the receiver given in nm, and B_{N} is the electrical noise equivalent bandwidth in the receiver. While the equation (4) relates the OSNR to the Q-factor for an NRZ square pulse that is unaffected by chromatic dispersion, it can be appreciated that it is advantageous to improve the Q-factor for a given OSNR. This is accomplished through exemplary embodiments of the present invention herein described. Stated differently, the pulse compression method of the exemplary embodiments result in an improved Q-factor for a given OSNR of an OSNR-limited optical link.

In accordance with an exemplary embodiment of the present invention, the Q-factor and BER, are improved in a long-haul optical link, by prechirping the optical signal at the transmit side 101 so the optical peak signal power in a “1” is increased relative to the case with no pre-chirping (i.e. the pulse shape is also changed). In a typical long-haul link, the net link dispersion is designed to be near zero. Pre-chirping in this case will not change the Q-factor or BER. However, if the link has residual dispersion (by design or because of an inability to eliminate all dispersion), and if this residual dispersion has the proper sign, the pre-chirp will, together with the residual dispersion, cause a pulse compression, and consequently a Q-value improvement.

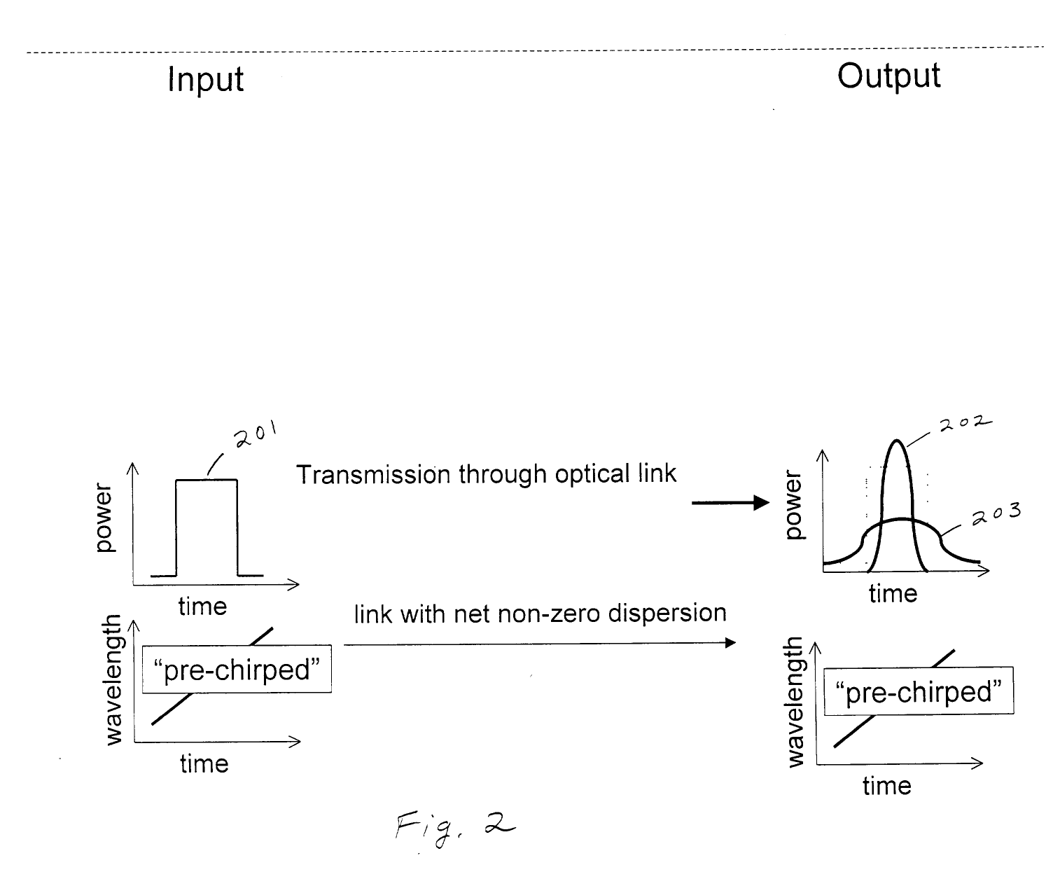

FIG. 2 illustrates pulse compression of a digital optical signal at the receive stage 104, resulting from the proper selection of the pre-chirp for the sign of the residual dispersion of the optical link. The first pulse 201 is a square pulse that is thereafter pre-chirped by the optical transmitter, so that at the receive stage 104 the second pulse 202 results. (For comparative purposes, first pulse 201 is superposed in dotted line over second pulse 202.) If the sign of the pre-chirp of the first pulse and the residual dispersion are not properly chosen, pulse dilation occurs such as shown by the third pulse 203. Clearly, this is not desired, and illustrates the need for the proper selection of the sign of the pre-chirp and the residual dispersion of the link. By any terminology used for net dispersion and chirp, the selection of the pre-chirp is made for the residual dispersion in the link to result in the compression of the optical pulse at the receive end. It is again noted that in addition to the proper selection of the sign, the magnitude of the pre-chirp is chosen to optimize the temporal compression of the output signal.

The pre-chirping at the transmit stage 101 results in the peak power of each digital ‘1’ waveform's being increased, compared to that which of first pulse 201, and particularly of the pulse-spread signal that would result from chromatic dispersion in the link. (It is noted that the dispersion-induced pulse spread signal would also resemble the third pulse 203.) Upon optical-to-electrical conversion, the compressed signal has a greater electrical peak power (and current I₁ in equation 2), compared to the signal that is not pre-chirped. The pulse compression thus results in an improved Q-factor (please refer to equation (2)), an improved electrical BER (please refer to equation (3)) and an improved electrical SNR compared to a signal that is not pre-chirped to effect the pulse-compression.

As will be appreciated by those skilled in the art, there must be a residual dispersion in the optical link to exact pulse compression. To wit, without this dispersion, pre-chirping has no affect on the temporal waveform of the optical signal.

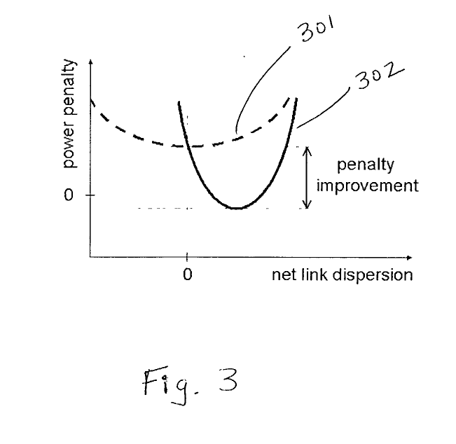

FIG. 3 is a graphical representation of the power penalty versus net link dispersion in accordance with an exemplary embodiment of the present invention. Again, the optical link is a long-haul link such as optical link 100 of FIG. 1. Curve 301 shows the power penalty versus dispersion for signals that are not pre-chirped (and thereby not compressed at the receive stage), while curve 302 shows the power penalty versus net link dispersion for a pre-chirped optical signal according to an exemplary embodiment of the present invention. In the present illustrative embodiment, the residual dispersion in the link is positive. As described previously, the pre-chirp is chosen so that pulse compression of the optical signal at the receive stage is effected. The fundamental reason for the improvement in the pre-chirped case (curve 302) is that as a consequence of the pulse compression at the system output, the peak power of the data (signal power) is higher. This results in a higher Q-value and a lower BER as well.

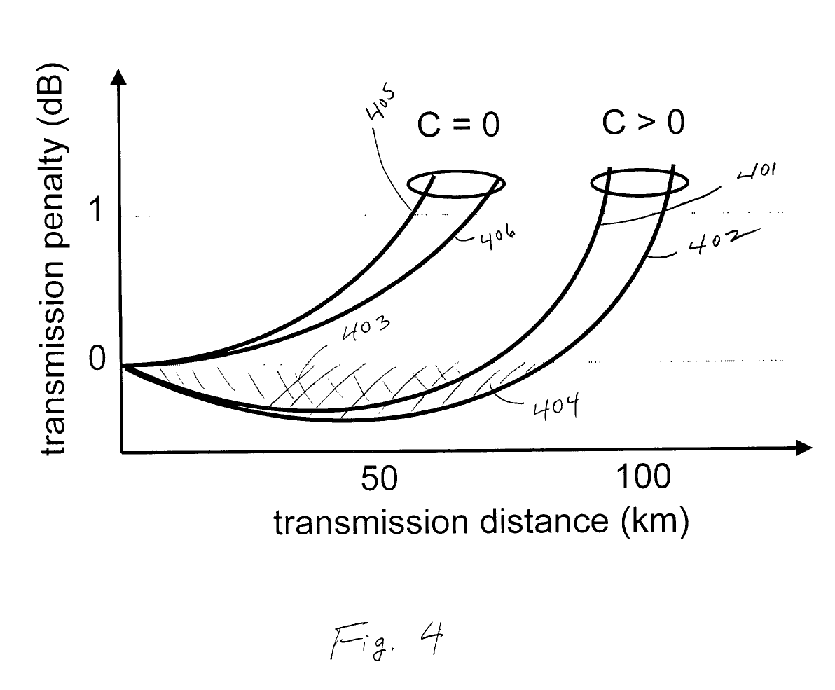

FIG. 4 shows yet another graphical representation of the affect of pre-chirp. In the illustrative embodiment, a range of positive chirp values are chosen to provide the pulse compression needed to improve the transmission penalty, Q-factor, SNR and BER. Curves 401 and 402 show a range of positive chirp (C>0) that result in an improved transmission over a link. The penalty improvement is pronounced in the shaded regions 403 and 404, where the transmission penalty is actually negative. Compared to the case where no chirp (C=0) is applied (curves 405 and 406), where the affects of dispersion is not addressed, the penalty improvement is pronounced. It is noted that the pre-chirped pulses in all instance result in an improved power penalty compared to curves 405 and 406, where no pre-chirp is applied.

According to illustrative embodiments of the present invention, for any given OSNR value (which relates to the time-average signal level only) the corresponding electrical SNR (or Q-value) can always be improved compared to a zero-chirp transmitter. In general, for any given acceptable penalty and residual dispersion range, there exists an optimal chirp for each OSNR that optimizes the performance.

The invention having been described in detail in connection through a discussion of exemplary embodiments, it is clear that modifications of the invention will be apparent to one having ordinary skill in the art having had the benefit of the present disclosure. Such modifications and variations are included in the scope of the present invention.

1. A method of improving the performance in an OSNR-limited optical link, the method comprising: selectively pre-chirping a transmitted optical signal, wherein said pre-chirping, in combination with a chromatic dispersion of the system, effects a net pulse compression at a receive end of the optical link.

2. A method as recited in claim 1, further comprising:
selecting a sign of said pre-chirp dependent on a sign of said chromatic dispersion so that said net pulse compression is obtained.

3. A method as recited in claim 1, wherein the link has a length in the range of approximately 200 km approximately 10,000 km.

4. A method as recited in claim 3, wherein the method is applied only once over said link.

5. A method as recited in claim 1, wherein a Q-factor is improved.

6. A method as recited in claim 1, wherein a BER is improved.

7. A method as recited in claim 1, wherein said pre-chirp is an up-chirp.

8. A method as recited in claim 1, wherein said pre-chirp is a down-chirp.

9. A method as recited in claim 1, wherein said chromatic dispersion is a residual dispersion.

10. An OSNR-limited optical communications link having a net non-zero chromatic dispersion therein, comprising: at least one chirped optical source, which selectively pre-chirps an optical signal, wherein said pre-chirped optical signal in combination with the net chromatic dispersion of the link, effects a net pulse compression at a receive end of the optical link.

11. An OSNR limited optical link as recited in claim 10, wherein a sign of said pre-chirp is selected dependent on a sign of said chromatic dispersion so that said net pulse compression is obtained.

12. An OSNR limited optical link as recited in claim 10, wherein the link has a length in the range of approximately 200 km approximately 10,000 km.

13. An OSNR limited optical link as recited in claim 10, wherein a Q-factor is improved in the link.

14. An OSNR limited optical link as recited in claim 10, wherein a BER is improved in the link.

15. An OSNR limited optical link as recited in claim 10, wherein said pre- chirp is an up-chirp.

16. An OSNR limited optical as recited in claim 10, wherein said pre-chirp is a down-chirp.

17. An OSNR limited optical link as recited in claim 10, further comprising at least one dispersion compensating device.
